(19) United States
(12) Patent Application Publication
(10) Pub. No.: US 2026/0215624 A1
(43) Pub. Date: Jul. 30, 2026

(54) A COFFEE BEAN GRINDER

(71) Applicant: Aarke AB, Stockholm (SE)

(72) Inventors: Melker MAGNERIUS, Stockholm (SE); Pedro ZEMBORAIN, Stockholm (SE); Per-Erik PÄRS, Stockholm (SE)

(73) Assignee: Aarke AB, Stockholm (SE)

(21) Appl. No.: 19/150,374

(22) PCT Filed: Jan. 24, 2024
(86) PCT No.: PCT/EP2024/051628

§ 371 Date: Jul. 23, 2025

(30) Foreign Application Priority Data
Jan. 26, 2023 (SE) 2350072-1
Jan. 26, 2023 (SE) 2350074-7

(51) Int. Cl. A47J 42/38; A47J 31/52

(52) U.S. Cl. CPC A47J 42/38; A47J 31/521

(57) ABSTRACT

A standalone coffee bean grinder and an associated coffee brewer. The coffee bean grinder is operable to receive a signal including water level information from the coffee brewer and to control the grinding mechanism thereof in dependence of the thus received water level information. The amount of water contained in a water container of the separate coffee brewer as indicated by the received water level information can thus determine the amount of coffee beans to be ground by the coffee bean grinder. This may allow for more accurate and repeatable brew quality and, also, the coffee drinking experience may be improved for certain users.

### PRIORITY

This patent application is an International PCT patent application, which claims priority to Swedish patent application no. 2350072-1 with the title “A COFFEE BEAN GRINDER” as well as Swedish patent application no. 2350074-7 with the title “A BREWER FOR PREPARING A BEVERAGE”, filed concurrently on Jan. 26, 2023.

### CO-EXISTING RELATED PATENT APPLICATIONS

This PCT patent application is filed concurrently with the PCT patent applications as per below and filed by the same applicant. Details on specific issues in these patent applications are to be considered as incorporated into each one of the related patent applications.

The related PCT patent applications are titled:
A BREWER FOR PREPARING A BEVERAGE
A BREWER WITH A SENSOR, A BREWER KIT AND
A METHOD FOR CONTROLLING A BREWER

### TECHNICAL FIELD

The present disclosure generally relates to a coffee bean grinder. In addition, the present disclosure relates to a kit of parts comprising the coffee bean grinder and a coffee brewer.

### BACKGROUND

Coffee preparation is the process of turning coffee beans into a beverage. While the particular steps vary with the type of coffee and with the raw materials, the process generally includes three basic steps: 1) raw coffee beans are roasted, 2) the roasted coffee beans are then ground, and 3) the ground coffee is then mixed with hot or cold water (depending on the method of brewing) for a specific time (brewed).

A coffee brewing process starting out from roasted coffee beans thus typically involves the steps of grinding the coffee beans and subsequently passing heated water through the ground beans in order to infuse the water with coffee flavour and aroma. A common type of coffee maker that employs this method is the so-called “drip-type” or “filter” coffee maker. Filter coffee makers typically comprise a water reservoir, or water container, and a brew basket for receiving coffee grounds. A delivery tube or other water passage takes water from the water reservoir, through a water heater, and delivers it to a spreader above coffee grounds in the brew basket. The heated water passes through the coffee grounds and in to a carafe, cup or other vessel.

### SUMMARY

It is in view of the above considerations and others that the various embodiments of the present invention have been made.

The inventors of the aspects and embodiments presented throughout this disclosure recognize that the art of making good coffee relies not only on the correct water temperature and wetting time, but also on the quantity of water and grind coffee used in preparing the brew. In addition, the grinding degree may have an impact on the end result. One of the problems with known coffee makers, and in particular domestic or home use coffee makers, is therefore the need to constantly measuring out exact quantities of water and coffee when making a brew. It is often the case that the number of cups, or quantity of coffee, vary from brew to brew. Thus, there is a need or desire to constantly adjust measurements and to work out exact quantities for each brew. One solution practiced by many users of domestic or home coffee makers is to measure out a known fixed quantity of coffee and water for each brew. For example, a user may place three scoops of coffee in the brew basket for one full load of water. This can result in coffee wastage or in more certain cases a shortage of coffee requiring a second brew which may only be partly consumed. As a result many users resort to rule of thumb guides such as “one scoop per cup plus one for the pot”. Such methods may be inadequate or imprecise often leading to variable brew quality which may impair the coffee drinking experience.

Coffee wastage may also lead to a negative climate impact. In addition, it is generally difficult for a user to know the exact or proper amount of coffee to dose since these quantities are typically not standardized by the coffee brewer manufacturers. To sum up, there is generally a risk of unnecessary coffee wastage which, in turn, can have a negative impact on the planet.

The present disclosure recognizes the fact that there is a need for alternatives to (e.g. improvement of) the existing art described above. It is a therefore a general object of this disclosure to present a novel coffee bean grinder as well as a novel kit of parts comprising a coffee bean grinder and a coffee brewer which address this and thus aim at solving, mitigating, alleviating, or eliminating at least some of the above or other disadvantages.

According to a first aspect, a coffee bean grinder is provided. The coffee bean grinder is a standalone coffee bean grinder. That is, the coffee bean grinder is not integral with the coffee brewer (coffee maker). In other words, the coffee bean grinder is separate and distinct from the coffee brewer.

Typically, but not necessarily, the coffee bean grinder may be a domestic coffee bean grinder, i.e. a coffee bean grinder for home use.

The coffee bean grinder comprises a coffee bean receptacle, a grinding mechanism for grinding coffee beans, and a grinder control unit for controlling the grinding mechanism.

In addition, the coffee bean grinder comprises a communication module operatively coupled to the grinder control unit, the communication module being configured to receive a first signal including water level information from a coffee brewer.

As used herein, the expression water level information should be understood in a broad sense. The water level information is indicative of a weight of the water in the water container of the coffee brewer or, alternatively, the amount of water (volume) contained in the water container of the coffee brewer, e.g., at a given point in time (such as prior to a brewing cycle).

The grinder control unit is additionally configured to control the grinding mechanism in dependence of received water level information, such that an amount of water contained in a water container of the coffee brewer as indicated by the received water level information determines the amount of coffee beans to be ground.

In advantageous embodiments, the communication module is configured to receive said first signal wirelessly.

Additionally, or alternatively, the communication module may be configured to receive said first signal over a wired connection.

In some embodiments, the communication module is configured to transmit a request signal to the coffee brewer for requesting water lever information from the coffee brewer. If so, the first signal may be received from the coffee brewer in response thereto. For example, the communication module may be configured to transmit the request signal wirelessly. Additionally, or alternatively, the communication module may be configured to transmit the request signal over a wired connection.

In some embodiments, the grinder control unit may be further configured to control the grinding mechanism in dependence of one or more user-selected parameters such that the combination of water level and the one or more user-selected parameters determine the amount of coffee beans to be ground. The one or more user-selected parameters may for instance include one or a combination of i) fineness of coffee, and ii) coffee strength.

In some embodiments, the grinder control unit is configured to receive a second signal including information about said one or more user-selected parameters.

In some embodiments, said second signal is received from the coffee brewer via the communication module. The communication module may be configured to receive said second signal wirelessly. Additionally, or alternatively, the communication module may be configured to receive said second signal over a wired connection.

Additionally, or alternatively, said second signal may be received wirelessly from a communication device via the communication module. The communication device may for example be a communication device from the group comprising: a smartphone, a tablet computer, a laptop computer, a desktop computer.

In some embodiments, said second signal may additionally, or alternatively, be received from a user interface integral with the coffee bean grinder. To this end, the coffee bean grinder may include a user interface through which a user can interact and operate the coffee bean grinder. The user interface may include control means for controlling any one or both of i) the fineness of coffee and ii) the coffee strength. In some embodiments, the control means include one or several knobs. In some embodiments, the user interface includes touch screens for interaction with the coffee bean grinder and for operation of the functionality thereof.

According to a second aspect, a kit of parts is provided. The kit of parts comprises the coffee bean grinder according to the first aspect. In addition, the kit of parts comprises a coffee brewer. The coffee brewer is separate and distinct from the coffee bean grinder. Also, the coffee brewer comprises a communication module configured to transmit the earlier-mentioned first signal including water level information to the coffee bean grinder. The water level information includes information about the water level in a water container of the coffee brewer as sensed by the coffee brewer. As used herein, the expression water level information should be understood in a broad sense. The water level information transmitted to the coffee bean grinder is therefore indicative of the weight of the water in the water container or, alternatively, the amount of water (volume) contained in the water container, e.g. at a given point in time (such as prior to a brewing cycle).

In some embodiments, the coffee brewer further comprises a water delivery pipe for supplying water from the water container to a water dispenser, a water detection means for determining a volume of water present in the water container, and a heating means for controlling the flow of water in the water delivery pipe. The coffee brewer is characterized in that the coffee brewer is configured such that a level of power supplied to the heating means is adapted in dependence of an output from the water detection means, said output being indicative of the volume of water determined to be present in the water container, in that the brewer is configured such that the level of power supplied to the heating means controls a flow rate of water through the water delivery pipe to the water dispenser, and in that the water detection means comprises a float and at least two position sensors, wherein each position sensor is configured to detect a vertical position of the float, and wherein the coffee brewer is configured to determine the water level in the water container, and thereby the volume of water in the water container, based on output from each position sensor, said output being indicative of a detected vertical position of the float.

According to a third aspect, a method is provided. The method is implemented in a coffee bean grinder comprising a coffee bean receptacle and a grinding mechanism for grinding coffee beans. The method comprises receiving a first signal including water level information from a coffee brewer (which is separate and distinct from the coffee bean grinder) and controlling the grinding mechanism in dependence of received water level information, such that an amount of water contained in a water container of the coffee brewer as indicated by the received water level information determines the amount of coffee beans to be ground by the coffee bean grinder.

According to a fourth aspect, there is provided computer program, comprising instructions which, when executed on at least one processor (e.g. at least one grinder control unit), cause the at least one processor to carry out the method according to the third aspect. A carrier containing the computer program of the fourth aspect is also provided. The carrier may be one of an electronic signal, an optical signal, a radio signal, or a computer readable storage.

Various aspects and embodiments described herein address the need or desire to improve the art of making good coffee. In the aspects and embodiments described herein, a user is no longer required to manually measure a known fixed quantity of coffee and water for every new brew. Instead, the grinding mechanism of the coffee bean grinder is operable to adapt the grinding mechanism automatically based on received water level information such that a water level (indicative of water weight/water volume) of the water container of the coffee brewer determines the amount of coffee beans to be ground. In turn, this may lead to better coffee usage and, hence, less coffee wastage. Furthermore, the aspects and embodiments described herein may lead to more accurate and repeatable brew quality. As a further bonus effect, the coffee drinking experience may be improved for users.

### BRIEF DESCRIPTION OF THE DRAWINGS

These and other aspects, features and advantages will be apparent and elucidated from the following description of various embodiments, reference being made to the accompanying drawings, in which:

FIG. 1 shows a schematic illustration of a coffee bean grinder, or coffee bean grinding machine;

FIG. 2 shows a perspective view of an embodiment of a coffee bean grinder;

FIG. 3A shows a cross sectional view of the coffee bean grinder in FIG. 2;

FIG. 3B also shows a cross sectional view of the coffee bean grinder in FIG. 2, but from a different angle compared with FIG. 3A;

FIG. 4 shows a kit of parts, here exemplified by schematic illustrations of a coffee brewer, an optional communication device and a coffee bean grinder shown in FIGS. 1-3;

FIG. 5 shows a signaling diagram of communications between the devices in FIG. 4 in accordance with one example implementation; and

FIG. 6 illustrates computer program which is downloadable to be installed on the coffee bean grinder in FIGS. 1-4.

### DETAILED DESCRIPTION OF EMBODIMENTS

The present invention will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like reference numbers refer to like elements throughout the description.

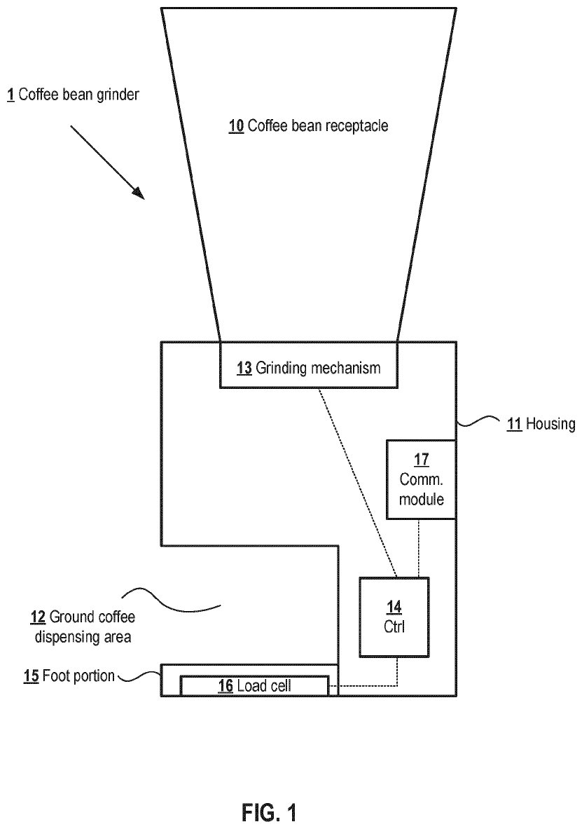

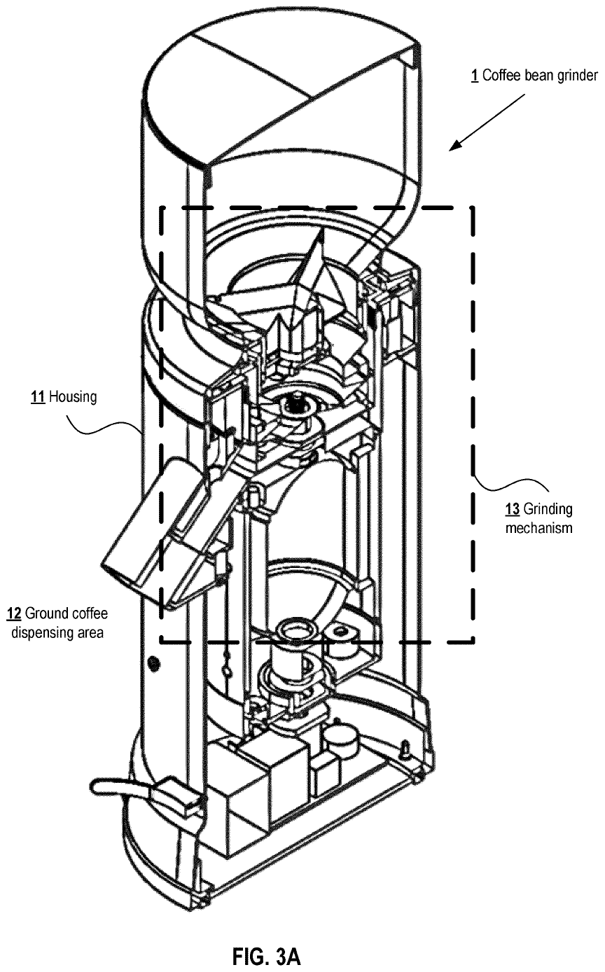

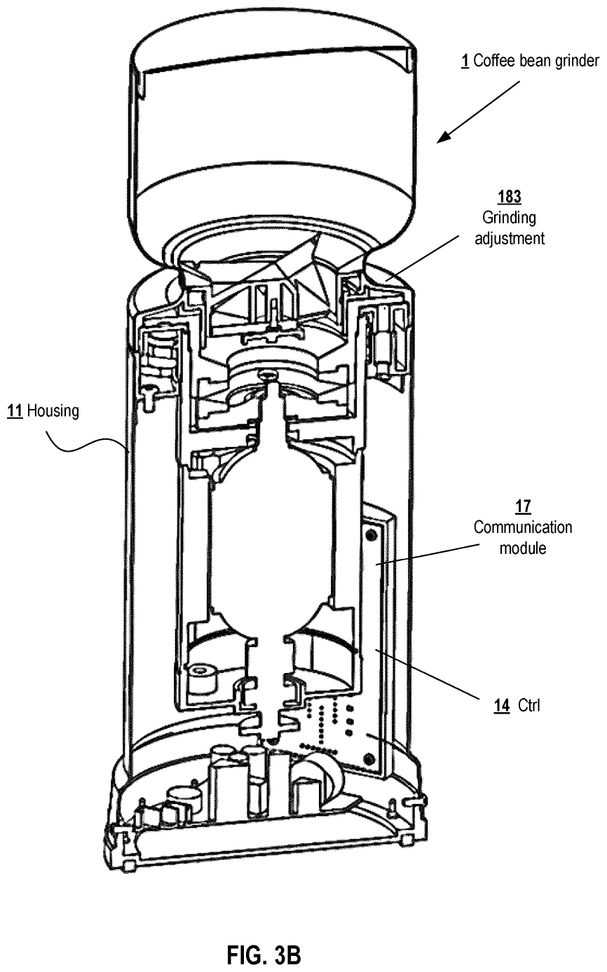

With reference to FIGS. 1-4, various aspects and embodiments of a coffee bean grinder 1 will now be described in further detail. As can be seen in FIGS. 1-4, the coffee bean grinder 1 has a separate housing 11. Usually on top of that housing 11 there is provided a coffee bean receptacle 10, sometimes referred to as the coffee bean container or grinder hopper. The coffee bean receptacle 10 is openable, or otherwise construed, to receive coffee beans to be grinded. At the bottom end of the coffee bean receptacle 10, which is typically converging towards the bottom, there is provided the actual grinding mechanism 13 or the grinder module, i.e. the actual grinding elements. The actual grinding elements typically include one ring-like stationary and ring-like rotating grinder element, the rotating grinder element being driven by a motor (e.g., the lowermost part of the grinding mechanism). There is furthermore provided an automatic adjustment mechanism to adjust the rotary speed of the motor, if need be the torque of the motor. The width of the slot between the two grinder elements may be manually adjusted to change or otherwise adapt a resulting grain size. For example, the grain size may be adjustable by means of a grinding adjustment means 183 (being part of the user interface 18 through which a user can interact with and operate functionality of the coffee bean grinder 1). In this example, the grinding adjustment means 183 includes rotary means such as a ring. By rotating the rotary means around the coffee bean receptacle 10 it is made possible to change or otherwise adapt a degree of grinding.

The grinding mechanism 13 per se is not a focus of the present disclosure and will therefore not be further discussed herein. Persons skilled in the art of the present disclosure appreciate that there exist various options for designing a grinding mechanism to address various needs and desires of the operation of the coffee bean grinder 1.

Control in the coffee bean grinder 1 is generally coordinated and carried out by a grinder control unit 14. In other words, the grinder control unit 14 is e.g. configured to control the grinding mechanism 13. The corresponding data lines (internal communications) are illustrated by dashed lines. Also the grinder typically comprises a user interface 18, e.g. including an input/output device for the user which communicates with the grinder control unit 14 or which is integral with the grinder control unit. Furthermore the coffee bean grinder 1 may optionally comprise a separate foot portion 15, which in turn may optionally comprise a load cell 16 for measuring the weight of the coffee which has been dispensed e.g. to a container, filter, or other ground coffee collector inserted into the ground coffee dispensing area 12 and put onto a corresponding holder cooperating with the foot portion 15/load cell 16. Also, this optional load cell 16 may be configured to be in data connection with the grinder control unit 14, the grinder control unit 14 thus being operable to receive information about the effective weight of the ground coffee filled into the container, filter, or other ground coffee collector.

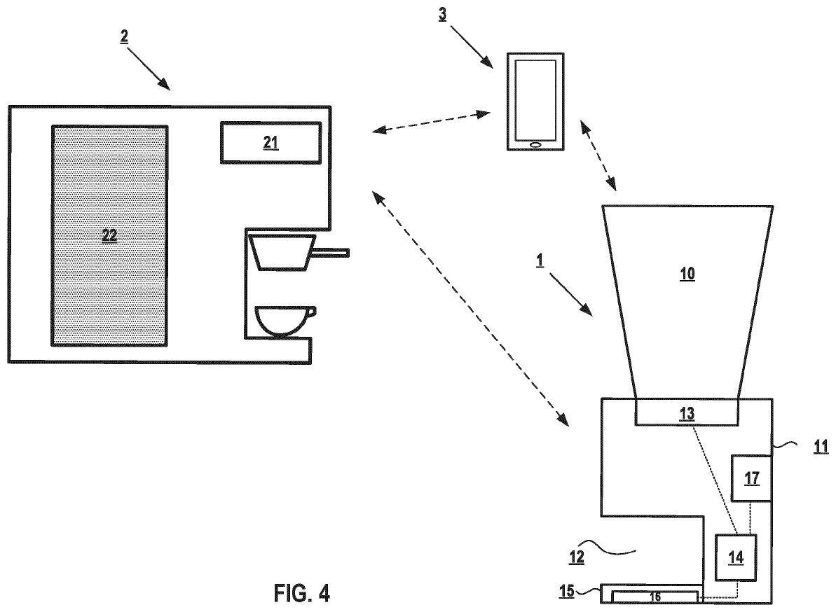

Reference is now also made to FIG. 4, which shows a kit of parts, here exemplified by schematic illustrations of a coffee brewer 2, an optional communication device 3 and the coffee bean grinder shown in any of FIGS. 1-3. By way of background, the coffee brewer 2 is separate and distinct from the standalone coffee bean grinder 1. The coffee brewer 2 comprises a communication module 21 configured to transmit a first signal including water level information to the coffee bean grinder 1. The water level information includes information about the water level in a water container 22 of the coffee brewer 2 as sensed, or otherwise determined, by the coffee brewer 2. As used herein, the expression water level information should be understood in a broad sense. The water level information is indicative of a weight of the water in the water container 22 of the coffee brewer 2 or, alternatively, the amount of water (volume) contained in the water container 22 of the coffee brewer 2.

As can be seen in FIG. 4, the coffee brewer 2 and the separate coffee bean grinder 1 can be communicatively coupled. In the illustrated example, the communication between the coffee brewer 2 and the separate coffee bean grinder 1 is wireless. The wireless communication may be implemented in various ways. For example, the wireless communication may utilize a radio frequency (RF) interface allowing the coffee brewer 2 to communicate with coffee bean grinder 1 and/or communication devices 3 through a radio frequency band through the use of different radio frequency technologies such as 5G NR (New Radio), LTE (Long Term Evolution), WCDMA (Wideband Code Division Multiple Access), or any other cellular network standardized by the 3rd Generation Partnership Project (3GPP), or any other wireless technology such as Wi-Fi, Bluetooth®, etcetera.

From the above discussion, it will be appreciated that a communication module 21 of the coffee brewer 2 may be configured to transmit/receive signals to the signals wirelessly to/from the coffee bean grinder 1, e.g., via a communication module 17. Likewise, the communication module 17 of the coffee bean grinder 1 may be configured to transmit/receive signals wirelessly to/from the coffee brewer 2, e.g., via the communication module 21.

As will be appreciated, in some embodiments the coffee brewer 2 and the coffee bean grinder 1 are operable to communicate signals to/from each other in a continuous manner. This way, for example, both the coffee brewer 2 and the coffee bean grinder 1 may be ready to use when a user activates, or otherwise polls, either one of the coffee brewer 2 or the coffee bean grinder 1.

Additionally, or alternatively, the communication between the coffee brewer 2 and the separate coffee bean grinder 1 may be realized over a wired connection (not shown). For example, the communication may be realized over a wired connection via the respective communication modules 21 and 17.

Reference is again made to FIG. 1 and FIG. 4 in particular, which illustrate that the communication module 17 is operatively coupled to the grinder control unit 14. In the example embodiments shown in FIGS. 1 and 4, these communication module 17 and the grinder control unit 14 are shown as separate components, or units. In other implementation, communication module 17 and the grinder control unit 14 may be part of a common, thus single, component or unit. The communication module is configured to receive the first signal including water level information from a coffee brewer 2 (FIG. 4). The grinder control unit 14 is further configured to control the grinding mechanism 13 in dependence of received water level information. This way, the weight or amount (volume) of water contained in the water container 22 of the coffee brewer 2 as indicated by the received water level information can determine a suitable amount of coffee beans to be ground.

The inventors of this disclosure have realized that there is certain ratio between the weight or amount (volume) of water in a water container 22 of the water brewer 2 and a corresponding suitable, or proper, amount of coffee beans to be ground. One possible relationship is disclosed in table below. The exact relationship between an amount of water in the water tank 22 of the coffee brewer 2 and the coffee bean grinder 1 should preferably be tested and evaluated for each specific user or user group in dependence of, e.g., needs, desires and taste preferences. According to certain tests and evaluations by the applicant of this disclosure, the following relationships are possible in certain situations.

TABLE 1
Nominal water to coffee relationship.

| Water in water container [grams] | Coffee beans [grams] |
|---|---|
| 250 | 15 |
| 375 | 22.5 |
| 500 | 30 |
| 625 | 37.5 |
| 750 | 45 |
| 1000 | 60 |
| 1250 | 75 |

By providing the water level information from the coffee brewer 2 to the coffee bean grinder 1, the coffee bean grinder 1 is operable to control the grinding mechanism 13 in dependence of this water level information such that an amount of water contained in a water container 22 of the coffee brewer 2 as indicated by this water level information determines, or otherwise concludes, a proper amount of coffee beans to be ground. This is advantageous for various reasons. For example, a user is generally not required to manually measure a known fixed quantity of coffee and water for each brew. Instead, the grinding mechanism 13 of the coffee bean grinder 1 is operable to adapt the grinding mechanism 13 automatically based on received water level information. In turn, this may lead to better coffee usage and, hence, less coffee wastage. Furthermore, this may lead to more accurate and repeatable brew quality. As a further bonus effect, the coffee drinking experience may be improved for users.

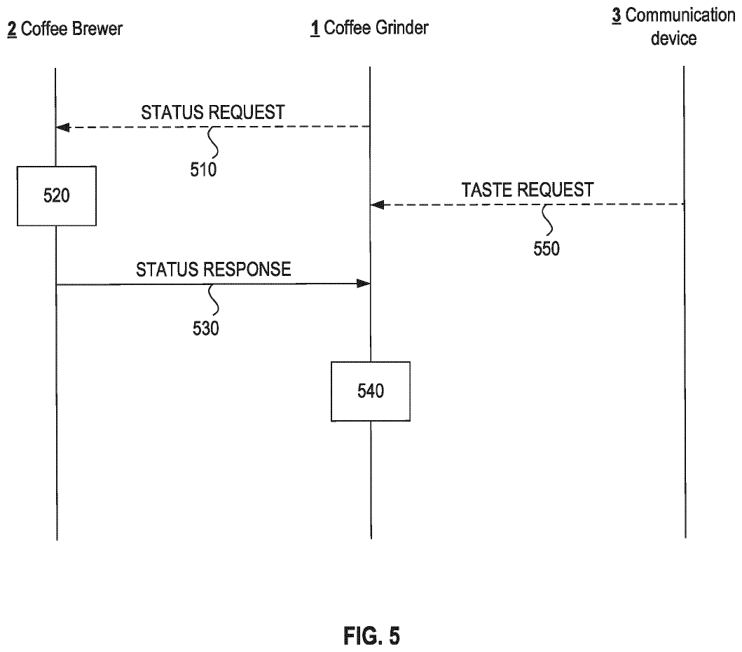

In some embodiments, the communication module 17 is configured to transmit a request signal to the coffee brewer 2 for requesting water lever information from the coffee brewer 2. If so, the first signal including the water level information is received from the coffee brewer 2 in response thereto. This will be illustrated in more detail with respect to an example implementation discussed with respect to FIG. 5.

In advantageous embodiments, the grinder control unit 14 is further configured to control the grinding mechanism 13 in dependence of one or more user-selected parameters. This way it is made possible that the combination of water level (weight/volume) and the one or more user-selected parameters determine the suitable amount of coffee beans to be ground. The one or more user-selected parameters may for example include fineness of coffee and/or coffee strength. Additionally, or alternatively, the type of roasting may also be a user-selectable parameter such that the grinding mechanism can take this into account too. For further details in this regard, reference is made to the description of action 550 as discussed in conjunction with FIG. 5

In advantageous embodiments, the grinder control unit 14 of the coffee bean grinder 1 is configured to receive a second signal including information about said one or more user-selected parameters. In some embodiments, said second signal may be received from the coffee brewer 2 via the communication module 17, either wirelessly or over a wired connection. Additionally, or alternatively, said second signal may be received wirelessly from a communication device 3 via the communication module 17. This communication device 3 may be any communication device such as a smartphone, a tablet computer, a laptop computer, or a desktop computer. In FIG. 4, the communication device 3 is illustrated as a smartphone. For example, an app may have been downloaded to and installed on the smartphone. The app may include computer program, which when executed by a processor of the smartphone, cause the smartphone to be operable to communicate with the communication module 17 of the coffee bean grinder 1. In some example, the app provides a user interface via a touchscreen of the smartphone whereby a user may interact with and operate the user interface to select one or more one or more parameters such as the desired fineness of coffee and/or coffee strength.

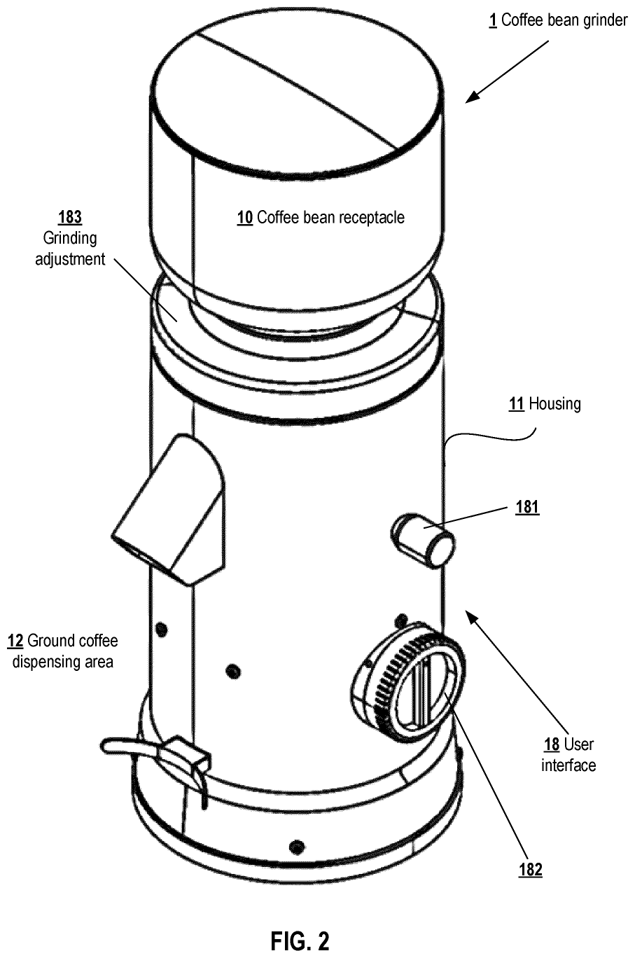

In some embodiments, said second signal may additionally, or alternatively, be received from a user interface 18 integral with the coffee bean grinder 1. In the example of FIG. 2, the user interface 18 includes control means 181, 182 in the form of knobs for controlling various functionality of the coffee bean grinder. In a current best mode implementation, one of the physical knobs 181 is operable to control the coffee strength and the other one of the physical knobs 182 can be interacted with and operated to select a desired number of cups. In some embodiments, control means 181,182 may be provided to control the desired fineness of coffee and/or the coffee strength.

In alternative embodiments, the physical knobs 181, 182 may be replaced with a touch-screen user interface having controllable virtual representations of the knobs.

By providing the coffee bean grinder 1 with the option of controlling the grinding mechanism 13 in dependence of received water level information in combination with user-selected parameters allow for an even better coffee usage and an even more accurate and repeatable brew quality. As a further bonus effect, the coffee drinking experience may be perceived as even better by some users.

### Implementation Example of Communications

Reference is now made to FIG. 5, which illustrates an example of a signalling diagram of communications between the coffee brewer 2 and the standalone coffee bean grinder 1 discussed in conjunction with FIGS. 1-4 and according to one example embodiment. In this example embodiment, the coffee brewer 2 is operable to respond to requests from the coffee bean grinder 1.

The communication between the coffee brewer 2 and the standalone coffee bean grinder 1 may be reduced into practice by utilizing a protocol developed by the applicant of this disclosure. This protocol is described herein by way of example so that this disclosure will be thorough and complete for those skilled in this art. Readers of this disclosure will however appreciate that the scope of protection conferred by the appended claims is in no way limited to this exemplary protocol. Rather, the inventive concept may be reduced into practice utilizing other alternative and suitable protocols as well. The exact protocol should preferably be tested and evaluated in dependence of various needs and demands of the coffee brewer 2 and the associated standalone coffee bean grinder 1.

In the example provided by this disclosure, the communication interface between the coffee brewer 2 and the coffee bean grinder 1 is asynchronous. The communication parameters are:
9600 bps
8 bits
No parity

All bytes of data are sent as two ASCII characters representing the hex value of the byte. For example, byte content 39 decimal=27 hex is transferred as two ASCII characters ‘2’ and ‘7’. In this way all single byte values can be transferred as two ASCII characters “00” up to “FF”.

Typically, but not necessarily, if a coffee bean grinder 1 is not connected, or communicatively coupled, to the coffee brewer 2 in this example there is no association between the two devices and no data traffic (communication) is generated by the coffee brewer 2.

Furthermore, each data packet has a character indicating a start of packet and another character indicating an end of packet. The last character in the packet preceding the end of packet character is a checksum byte calculated as the last 8 bits of the sum of all data bytes, inverted. The Start of packet byte is not included in the checksum, only the Data field.

| Field | ASCII char | Hex value | #Bytes |
|---|---|---|---|
| Start of packet | < | 0x3C | 1 |
| Data | 0-9 | <0x30-0x39> | N*2 |
| | A-F | <0x41-0x46> | N = #Bytes |
| | | | in data packet |
| Checksum | 0-9 | <0x30-0x39> | 2 |
| | A-F | <0x41-0x46> | |
| End of packet | > | 0x3E | 1 |

The Data part of a packet always starts with a Packet ID byte. Bit 7 of the ID indicates if it is a Request or a Response.
Bit 7-0 Request
Bit 7=1 Response

### Action 510 (Request Signal)

The coffee bean grinder 1 transmits 510, or otherwise sends, a request signal (STATUS REQUEST) to the coffee brewer 2. The request signal is a signal for requesting water lever information from the coffee brewer 2. In words, the coffee brewer 2 can receive 510 the request signal from the coffee bean grinder 1.

Typically, but not necessarily, the coffee brewer 2 transmits or otherwise sends a signal including the water level information to the coffee bean grinder 1 only at times when it is not in a brewing cycle. In some implementations, the request signal (STATUS REQUEST) may, e.g., be transmitted on a regular basis at a time interval of 1, 2, 3, 4 or 5 seconds, advantageously 1 second.

| Packet ID | 0x01 |
|---|---|
| Parameters | None |

The packet sent on the communications interface is:

| <30313338> | |
|---|---|
| < | Start of packet |
| 30 31 | Packet ID. ASCII values for 0 and 1 |
| 33 38 | Checksum. ASCII values for 3 and 8 |

```
  0x33 + 0x30 + 0x33 + 0x31 = 0xC7
  Last 8-bits = 0xC7 Inverted value = 0x38
```

### Action 520 (Water Level Determination)

The water level of the water container 22 of the coffee brewer 2 is determined 520, or otherwise calculated. As discussed above, water level should be understood in a broad sense and is indicative of a weight of the water in the water container of the coffee brewer or, alternatively, the amount of water (volume) contained in the water container 22 of the coffee brewer 2 in question.

The water level determination, or calculation, per se is not a main focus of the present disclosure and will therefore only be discussed briefly herein. Persons skilled in the art of the present disclosure appreciate that there exist various options for designing a grinding mechanism to address various needs and desires of the operation of the coffee bean grinder 1. Possible ways of performing the water level determination at the coffee brewer 2 are discussed and disclosed in the Swedish patent application no. Sweden patent application no. 2350074-7.

For example, the water level determination may be reduced into practice by providing a coffee brewer for preparing coffee, the brewer comprising: (1) a water tank (a.k.a, water container), (2) a water delivery pipe for supplying water from the water tank to a water dispenser, (3) a water detection means for determining a volume of water present in the water tank, and (4) a heating means (104) for controlling the flow of water in the water delivery pipe (102).

The brewer is characterized in that the brewer is configured such that a level of power supplied to the heating means is adapted in dependence of an output from the water detection means, said output being indicative of the volume of water determined to be present in the water tank, in that the brewer is configured such that the level of power supplied to the heating means controls a flow rate of water through the water delivery pipe to the water dispenser, and in that the water detection means comprises a float and at least two position sensors, wherein each position sensor is configured to detect a vertical position of the float, and wherein the brewer is configured to determine the water level in the water tank, and thereby the volume of water in the tank, based on output from each position sensor, said output being indicative of a detected vertical position of the float.

It should be appreciated that this disclosure thus suggests a kit of parts, comprising: (a) the coffee bean grinder according the various aspects and embodiments of this disclosure; and (b) a coffee brewer as discussed here. The coffee brewer is separate and distinct from the coffee bean grinder, the coffee brewer comprising a communication module configured to transmit said first signal including water level information to the coffee bean grinder, the water level information including information about the water level in a water container (water tank) of the coffee brewer as sensed by the coffee brewer.

### Action 530 (Water Level Information Signal)

The coffee brewer 2 transmits 530 a signal including water level information to the coffee bean grinder 1. In this example, this signal is transmitted, or otherwise sent, in response to the receipt of the request signal in action 510. Therefore, the signal including the water level information is called STATUS RESPONSE in the example shown in FIG. 5. As will be appreciated, the STATUS RESPONSE may include water level information and optionally also other status parameters of the coffee brewer 2.

The coffee bean grinder 1 accordingly receives the STATUS RESPONSE signal from the coffee brewer 2.

In this example, water level is a 16-bit parameter (2 bytes) where bits 8-15 is sent in the first byte and bits 0-7 in the second byte from the coffee brewer 2 to the coffee bean grinder 1. The value corresponds to, or is otherwise indicative of, the weight (e.g., number of grams of water) in the water container 22 (FIG. 4). A water level value of 0 for instance indicates an empty water container 22.

| Packet ID | 0x81 |
|---|---|
| Brewer status | 0x00-0xFF |
| | Bit 0: Brewer active, 1 if active |
| | Bit 1-7: Bits for other status parameters |
| Water level, H | 0x00-0xFF, high byte |
| Water level, L | 0x00-0xFF, low byte |

### EXAMPLE

If the brewer is not active (not currently brewing) and the water tank contains 500 grams of water the following is sent on the communications interface:

| | |
|---|---|
| <38313030303146344432> | |
| < | Start of packet |
| 38 31 | Packet ID. ASCII values for 8 and 1 |
| 30 30 | Brewer status. ASCII values for 0 and 0 |
| 30 31 | Water level. High byte. ASCII values for 0 and 1 |
| 46 34 | Water level, Low byte. ASCII values for F and 4. |
| | Water level value = 0x01F4 = 500 decimal |
| 44 32 | Checksum. ASCII values for D and 2 |
| | Total sum = 0x32D |
| | Last 8-bits = 0x2D Inverted value 0xD2 |

### Action 540 (Grinding Control)

The coffee bean grinder 1 controls 540 its grinding mechanism in dependence of received water level information. In other words, the coffee bean grinder may interpret the received water level information to determine, or otherwise conclude, the amount (weight/volume) of water contained in the water container 22 of the associated coffee brewer 2. This way, it is made possible to control the grinding mechanism such that the amount of water contained in the water container 22 as indicated by the received water level information determines the amount of coffee beans to be ground.

The exact relationship between an amount of water in the water tank 22 of the coffee brewer 2 and the coffee bean grinder 1 should preferably be tested and evaluated for each specific user or user group in dependence of, e.g., needs, desires and taste preferences. According to certain tests by the applicant of this disclosure, the following relationships are possible in certain situations:

TABLE 2
Nominal water to coffee relationship.

| Water in water container [grams] | Coffee beans [grams] |
|---|---|
| 250 | 15 |
| 375 | 22.5 |
| 500 | 30 |
| 625 | 37.5 |
| 750 | 45 |
| 1000 | 60 |
| 1250 | 75 |

### Action 550 (Taste Request Signal)

As discussed above, the grinding mechanism of the coffee bean grinder may additionally be controlled 540 in dependence of user-selected parameters such as the fineness of coffee and/or strength of the coffee.

In the example of FIG. 5, a user may interact with and operate an app of a smartphone to select, e.g., a desired strength setting. This is exemplified below. The exact relationship between a strength setting and a corresponding weight offset factor should advantageously be tested and evaluated for each specific user or user group in dependence of, e.g., needs, desires and taste preferences.

TABLE 3
Relationship between strength setting and selected weight offset factor
Strength setting

| Strength setting | Weigth offset factor |
|---|---|
| −4 | 0.700 |
| −3 | 0.775 |
| −2 | 0.850 |
| −1 | 0.925 |
| 0 | 1.000 |
| 1 | 1.075 |
| 2 | 1.150 |
| 3 | 1.225 |
| 4 | 1.300 |

In a connected mode, i.e. when the coffee bean grinder 1 and its associated coffee brewer 2 are in communication with each other, the following equation or formula could for example be envisaged:

$$Target amount coffee = Coffee per gram water * Grams measured water * Weight offset factor$$

The coffee per gram water could, e.g., be pre-set to a nominal value of 60 per 1000 grams of water.

Optionally, it is also possible to take a grind size factor into account in the formula above in some implementations. For example, in some embodiments, the grinder mechanism 13 may further incorporate sensing means to be able to sense the distance between the grinding elements. The output from such sensing means may then be taken into account by the grinding mechanism 13 to improve the accuracy even further.

In this example, the user interacts with and operates an app of a smartphone to select, e.g., a desired strength setting, and send a TASTE REQUEST signal to the coffee bean grinder 1 such that the coffee bean grinder can adapt its control of the grinding mechanism accordingly. It should be appreciated though that the user-selected parameters could alternatively, or additionally, be selected by the user at a user interface of the coffee bean grinder 1 (and/or the coffee brewer 2) as discussed herein.

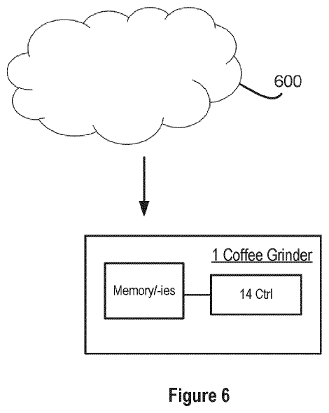

Turning now to FIG. 6, another aspect will be briefly discussed. FIG. 6 shows an example of a computer-readable medium, in this example computer program 600 being downloadable to be installed at a coffee bean grinder 1. Computer program 600 comprises instructions which, when executed on a processor (aka coffee bean grinder control unit 14), cause the processor to carry out the methods described throughout this disclosure. In other words, instructions can be loaded into a memory (which may be separate to or integral with the coffee bean grinder control unit denoted 14). Upon execution of said instructions by the processor, the coffee bean grinder 1 is thus caused to execute methods or procedures according to any one of the embodiments described herein.

The various aspects and embodiments of the standalone coffee bean grinder 1 and its associated coffee brewer 2 described throughout this disclosure address the need or desire to improve the art of making good coffee. The aspects and embodiments described herein may remedy a user from having to manually measure a known fixed quantity of coffee and water for each brew. Instead, the grinding mechanism of the coffee bean grinder is operable to adapt the grinding mechanism automatically based on received water level information such that a water level (indicative of water weight/water volume) of the water container of the coffee brewer determines the amount of coffee beans to be ground. In turn, this may lead to better coffee usage and, hence, less coffee wastage. This may have a positive impact on the climate in a longer run. Furthermore, the aspects and embodiments described herein may lead to more accurate and repeatable brew quality. As a further bonus effect, the coffee drinking experience may be improved for users.

Modifications and other variants of the described aspects and embodiments will come to mind to one skilled in the art having benefit of the teachings presented in the foregoing description and associated drawings. Therefore, it is to be understood that the embodiments are not limited to the specific example aspects and embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A coffee bean grinder, comprising:
a coffee bean receptacle,
a grinding mechanism for grinding coffee beans, and
a grinder control unit for controlling the grinding mechanism, wherein
the coffee bean grinder further comprises a communication module operatively coupled to the grinder control unit, the communication module being configured to receive a first signal including water level information from a coffee brewer, the water level information being indicative of a weight of water contained in a water container of the coffee brewer, wherein the coffee brewer is separate and distinct from the coffee bean grinder, and wherein the grinder control unit is configured to control the grinding mechanism in dependence of received water level information, which is indicative of the weight of water contained in the water container of the coffee brewer such that the weight of water contained in the water container of the coffee brewer as indicated by the received water level information determines the amount of coffee beans to be ground.

2. The coffee bean grinder according to claim 1, wherein the communication module is configured to receive said first signal wirelessly.

3. The coffee bean grinder according to claim 1, wherein the communication module is configured to receive said first signal over a wired connection.

4. The coffee bean grinder according to claim 1, wherein the communication module is configured to transmit a request signal to the coffee brewer for requesting water lever information from the coffee brewer, and wherein the first signal is received from the coffee brewer in response thereto.

5. The coffee bean grinder according to claim 4, wherein the communication module is configured to transmit the request signal wirelessly.

6. The coffee bean grinder according to claim 4, wherein the communication module is configured to transmit the request signal over a wired connection.

7. The coffee bean grinder according to claim 1, wherein the grinder control unit is further configured to control the grinding mechanism in dependence of one or more user-selected parameters such that the combination of water level and the one or more user-selected parameters determine the amount of coffee beans to be ground.

8. The coffee bean grinder according to claim 7, wherein the one or more user-selected parameters include one or a combination of i) fineness of coffee, and ii) coffee strength.

9. The coffee bean grinder according to claim 7, wherein the grinder control unit is configured to receive a second signal including information about said one or more user-selected parameters.

10. The coffee bean grinder according to claim 9, wherein said second signal is received from the coffee brewer via the communication module.

11. The coffee bean grinder according to claim 10, wherein the communication module is configured to receive said second signal wirelessly.

12. The coffee bean grinder according to claim 10, wherein the communication module is configured to receive said second signal over a wired connection.

13. The coffee bean grinder according to claim 9, wherein said second signal is received wirelessly from a communication device via the communication module.

14. The coffee bean grinder according to claim 13, wherein communication device is a communication device from the group comprising: a smartphone, a tablet computer, a laptop computer, a desktop computer.

15. The coffee bean grinder according to claim 9, wherein said signal is received from a user interface-integral with the coffee bean grinder.

16. The coffee bean grinder according to claim 15, wherein the user interface includes control means for controlling any one or both of i) the fineness of coffee and ii) the coffee strength.

17. (canceled)

18. A kit of parts, comprising:
the coffee bean grinder according to claim 1; and
a coffee brewer which is separate and distinct from the coffee bean grinder, the coffee brewer comprising a communication module configured to transmit said first signal including water level information to the coffee bean grinder, the water level information including information about the weight of water contained in a water container of the coffee brewer as sensed by the coffee brewer.

19. The kit of parts according to claim 18, wherein the coffee brewer further comprises a water delivery pipe for supplying water from the water container to a water dispenser, a water detection means for determining a volume of water present in the water container, and a heating means for controlling the flow of water in the water delivery pipe, and wherein the coffee brewer is configured such that a level of power supplied to the heating means is adapted in dependence of an output from the water detection means, said output being indicative of the volume of water determined to be present in the water container, in that the brewer is configured such that the level of power supplied to the heating means controls a flow rate of water through the water delivery pipe to the water dispenser, and in that the water detection means comprises a float and at least two position sensors, wherein each position sensor is configured to detect a vertical position of the float, and wherein the coffee brewer is configured to determine the water level in the water container, and thereby the volume of water in the water container, based on output from each position sensor, said output being indicative of a detected vertical position of the float.

20. A method implemented in a coffee bean grinder comprising a coffee bean receptacle and a grinding mechanism for grinding coffee beans, the method comprising:
receiving a first signal including water level information from a coffee brewer, which is separate and distinct from the coffee bean grinder, the water level information being indicative of a weight of water contained in a water container of the coffee brewer, and
controlling the grinding mechanism in dependence of received water level information, such that the weight of water contained in the water container of the coffee brewer as indicated by the received water level information determines the amount of coffee beans to be ground by the coffee bean grinder.

21. Computer program, comprising instructions which, when executed on at least one processor, cause the at least one processor to carry out the method according to claim 20.

22. (canceled)
